(19) United States
(12) Patent Application Publication
(10) Pub. No.: US 2020/0261917 A1
(43) Pub. Date: Aug. 20, 2020

(54) WEDGE RING AUTO UNLOCK SYSTEM AND METHOD

(71) Applicant: McCloskey International Limited, Keene (CA)

(72) Inventors: Dennis Duellman, Cudahy, WI (US); Alan Eisner, Cudahy, WI (US); Andrzej Krol, Keene (CA); Marian Ando, Cudahy, WI (US)

(73) Assignee: McCloskey International Limited, Keene (CA)

(21) Appl. No.: 16/280,453

(22) Filed: Feb. 20, 2019

(51) Int. Cl. B02C 2/04

(52) U.S. Cl. CPC B02C 2/045

(57) ABSTRACT

Embodiments disclosed herein provide a cone crusher having a bowl support and a stationary frame to which the bowl support may be mounted, the frame including an outwardly-facing threaded portion. A wedge structure may be disposed between the bowl support and the threaded portion of the frame, the wedge structure including an inwardly-facing threaded portion, the threads of which complement the outwardly facing threaded portion of the frame. Means may be provided for exerting an upward force on the wedge structure to move the wedge structure from an original position to an operational position during crushing operations and means may be provided for exerting a downward force on the wedge structure to return the wedge ring to the original position following crushing operations.

### TECHNICAL FIELD

The described embodiments relate to cone crushers and more specifically to the operation of wedge rings that are sometimes used in cone crushers.

### BACKGROUND

Rock crushers reduce the size of rocks in order to provide material for roadbeds, concrete, building foundations and the like. By definition, rock crushers need to be heavy duty to avoid breakage and bending during the crushing process. Rock crushers may be categorized as cone crushers, jaw crushers, and impact crusher, but this disclosure will focus on cone crushers. Cone crushers break up rocks and other hard material by squeezing or compressing the rocks between a convex, gyrating cone and a concave, stationary bowl, both of which are covered by hardened wear surfaces. The hardened surface on the bowl is called a mantle while a liner is mounted to the surface of the bowl.

The spacing between the bowl liner and the mantle at any given point opens and closes as the cone gyrates relative to the bowl. This space between the liner and the mantle is typically called the crushing space. Rocks are fed into the crushing space and slide down between these surfaces as the space opens with the gyration of the cone, and the rocks are crushed as the space closes. Because it is desirable to be able to vary the degree of reduction of the rocks that are discharged from rock crushers, the spacing between the cone and the bowl is adjustable. This is normally effected by including complementing inwardly- and outwardly-facing threads on the frame and on a wedge ring that is typically disposed between the cone and a bowl support, to which the bowl is mounted. To install the bowl into the cone and frame, the bowl is rotated such that the outwardly- and inwardly-facing threads guide the bowl into position. Once installed, by rotating the bowl support, the bowl can be moved up and down, or away from or toward the cone. This in turn will control the size of the rocks that can pass out of the crusher space.

Wedge rings are annular members that extend around the cone and are sometimes supported by a plurality of wedge ring cylinders spaced around the crusher that exert an upward force on the wedge ring. This upward force causes the inwardly-facing wedges or threads of the wedge ring to ride up the complementing outwardly-facing threads of the frame and cone. This causes the wedge ring to expand, which is permitted because the wedge ring typically has a break or gap in it. This outward expansion of the wedge ring presses against the bowl support, creating friction that maintains the bowl support and thus the bowl in position during crushing operations.

In the process of rock reduction, it is not uncommon for a large chunk of very hard rock, such as granite or basalt, or a piece of metal, sometimes called tramp iron, to enter the crusher. One example of tramp iron is a tooth from a rock-digging bucket. If the uncrushable material is larger than the maximum allowed size for passing through the cone crusher, such material can damage the crusher if there is no relief mechanism in place.

Rock crushers typically accommodate these uncrushables through a mechanism known as tramp iron relief systems. As noted above, the crusher space is adjustable. However, the upper assembly, including the bowl, is mounted relative to the frame in such a way as to allow lifting of the bowl relative to the cone in the event uncrushables enter the crushing space. The relief system typically includes hydraulic clamping cylinders, sometimes called relief cylinders or tramp cylinders, having pressurized pistons which serve to resist the lifting of the bowl. When the resistance of the clamping pistons is exceeded, at least one of the clamping cylinder relief valves pops open and the bowl assembly, including the bowl, will lift away from the cone and allow passage of the uncrushables. Once the uncrushables have passed through the crusher, the hydraulic fluid is pumped back into the clamping cylinders, thus causing the bowl to resume its original position and the crushing space to revert back to its normal dimension.

The clamping cylinders can typically perform their function to release the bowl and bowl support despite the outward pressure and friction between the bowl support and the wedge ring; that is, the opening and closing forces from the clamping cylinders will exceed the friction forces of the wedge ring against the bowl support so that the bowl support can move upwardly and downwardly with respect to the wedge ring and the frame, which bears the cone.

When the crusher is shut down, the wedge ring cylinders release the upward pressure on the wedge ring, which theoretically permits gravity to cause the wedge ring to drop down. This permits the wedge ring threads to ride down the outwardly facing threads of the cone, releasing the outward pressure on the bowl support. However, the forces of gravity are often not enough to cause the wedge ring to drop to its original lowered position, given the presence of debris, rust or other impediments present in and around the wedge ring. This causes difficulty because, for example, if the bowl needs to be removed to replace or repair the liner, the outward pressure of the raised wedge ring on the bowl support prevents the bowl from being lifted off of the crusher.

Others have dealt with this issue by including using rods to pound down on the wedge ring but if this is not done progressively and evenly around the wedge ring, the ring might jam and create even more of a problem. Others have included long, threaded bolts spaced around the ring but, again, this needs to be done evenly to avoid jamming. It may also be possible to simply force the bowl support up to unlock a jammed wedge ring using a plurality of evenly-spaced jacks. This would also have to be done evenly and progressively to avoid exacerbating the jam. In any event, installation of long bolts, jacks or the like can add to the weight and the expense of the crusher.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 is a side elevation sectional view of a crusher in which a first embodiment may be incorporated;

FIG. 2 is a fragmentary side elevation sectional view of the embodiment of FIG. 1 showing the wedge ring and frame threads in their relaxed, non-operating state;

FIG. 3 is a fragmentary side elevation sectional view of the embodiment of FIG. 1, corresponding to FIG. 2 except that the wedge ring is in its elevated state during crushing operations;

FIG. 4 is a top plan view of the crusher of FIG. 1 with the bowl components removed;

FIG. 5 is a fragmentary, enlarged view of a gap in the wedge ring depicted in FIG. 4;

FIG. 6 is a fragmentary side elevation view of the wedge ring and frame threads in their relaxed position, depicting the spring arrangement of the embodiment of FIG. 1;

FIG. 7 is a fragmentary perspective view of the depicted embodiment with the upper bowl components removed but showing a possible disposition of the springs of the depicted embodiment evenly-spaced around the wedge ring;

FIG. 8 is a fragmentary side elevation sectional view of a second embodiment showing the wedge ring and frame threads in their relaxed, non-operating state; and

FIG. 9 is a fragmentary side elevation sectional view of a third embodiment showing the wedge ring and frame threads in their raised, operating state.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense.

Various operations may be described as multiple discrete operations in turn, in a manner that may be helpful in understanding embodiments; however, the order of description should not be construed to imply that these operations are order-dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Embodiments disclosed herein provide a cone crusher having a bowl support and a stationary frame to which the bowl support may be mounted, the frame including an outwardly-facing threaded portion. A wedge structure may be disposed between the bowl support and the threaded portion of the frame, the wedge structure including an inwardly-facing threaded portion, the threads of which complement the outwardly facing threaded portion of the frame. Means may be provided for exerting an upward force on the wedge structure to move the wedge structure from an original position to an operational position during crushing operations and means may be provided for exerting a downward force on the wedge structure to return the wedge ring to the original position following crushing operations.

The means for exerting upward and downward forces may provide force at a plurality of spaced points around the wedge structure. The means for exerting an upward force may comprise at least one fluid powered cylinder disposed under the wedge structure. The means for exerting a downward force may comprise a plurality of spaced springs disposed above the wedge structure. The means for exerting a downward force may comprise a plurality of spaced, fluid powered cylinders disposed above the wedge structure. The means for exerting an upward force and the means for exerting a downward force may comprise a plurality of double-acting fluid powered cylinders disposed adjacent and mounted to the wedge structure.

Embodiments disclosed herein may also provide a cone crusher having a bowl support and a crusher bowl mounted to the bowl support, and a cone mounted to a stationary frame including an outwardly-facing threaded portion. An annular wedge ring may be disposed between the bowl support and the threaded portion of the frame, the wedge ring including an inwardly-facing threaded portion, the threads of which complement the outwardly facing threaded portion of the frame. A plurality of spaced, fluid-powered wedge ring cylinders may be disposed around and under the wedge ring such that the wedge ring may be forced upwardly from an original position to an operational position by the wedge ring cylinders during crushing operations. A plurality of springs may be disposed around the wedge ring for exerting a downward force on the wedge ring to return the wedge ring to the original position following crushing operations.

Embodiments may also include a wedge ring biasing system for biasing upwardly and downwardly a threaded, annular wedge ring used in a cone crusher. The wedge ring may be disposed between a cone crusher frame having threads that complement the threads of the wedge ring and a cone crusher bowl support to which is mounted a crusher bowl. The system for biasing the wedge ring upwardly may comprise a plurality of fluid-powered cylinders disposed under and around the wedge ring and the system for biasing the wedge ring downwardly may comprise a plurality of springs disposed above and around the wedge ring.

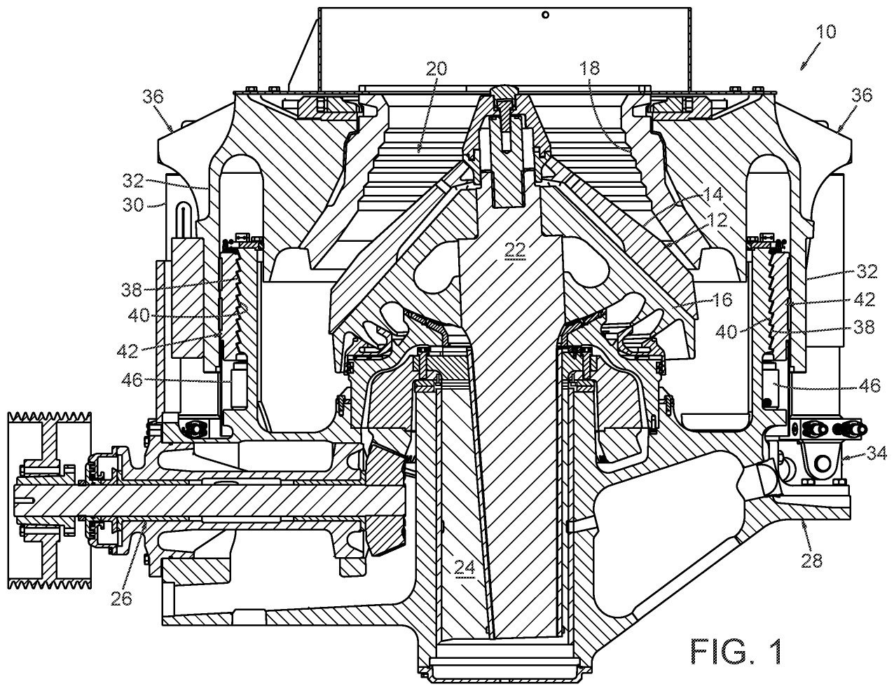

FIG. 1 shows a cone crusher 10 that includes a cone body 12 with a hardened mantle 14 disposed over it. A bowl 16 is positioned opposite mantle 14, with a hardened bowl liner 18 positioned on it. The space defined between mantle 12 and bowl liner 18 is referred to as the crushing space 20. Rocks to be crushed enter this space.

Cone body 12 is mounted to a central shaft 22, which is gyrated from side to side by a rotating eccentric 24. The eccentric is driven by a drive shaft 26. With eccentric 24 gyrating central shaft 22 from side to side, rocks entering the so-called close side, where mantle 14 is closest to liner 18 or where crushing space 20 is smallest, will be crushed between the mantle and the liner.

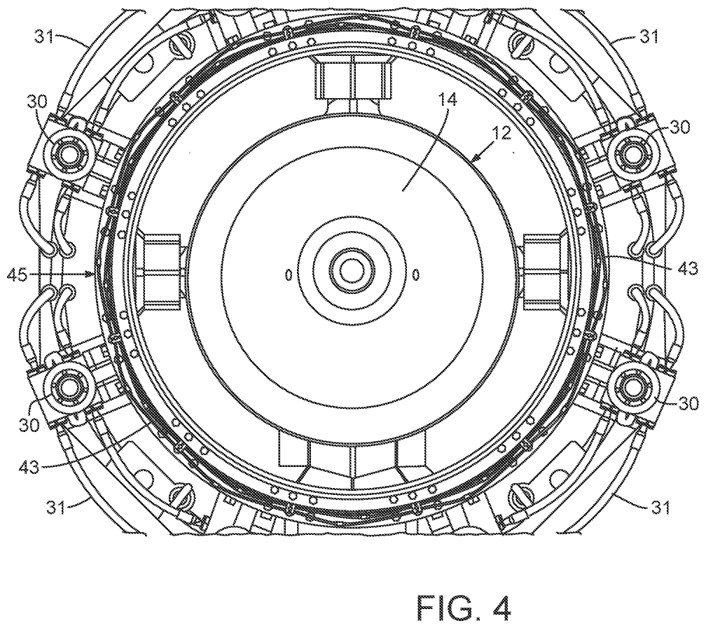

A crusher frame 28 provides a support for central shaft 22, eccentric 24, drive shaft 26, and many of the other components. To provide protection from excessive forces generated when non-crushables enter crushing space 20, a series of clamping cylinders 30 are positioned around the crusher. As shown in FIG. 4, clamping cylinders 30 are evenly-spaced around the periphery of crusher 10 and include hydraulic lines 31 extending between them. The clamping cylinders are mounted between crusher frame 28 and a bowl support 32 at clamping cylinder mounts 34 and 36, respectively. Bowl 16 is mounted to bowl support 32 so that when uncrushables enter crushing space 20, excessive upward force is generated. Clamping cylinders 30 sense the excessive pressure being generated from the uncrushables, and the clamping cylinder(s) on that side of the crusher pop open, relieving the pressure and protecting the crusher from damage.

An outwardly-facing surface of crusher frame 28 includes a series of threads 38, which complement and mesh with a similar series of threads 40 extending inwardly from an annular wedge ring 42. The term “annular” as used herein means that the wedge ring is generally circular. In the depicted embodiment the wedge ring extends substantially entirely around the periphery of cone crusher 10. In some cases the wedge ring may be described as being a “wedge structure.” In that event the wedge structure does not need to be extend substantially entirely around the periphery of the cone crusher.

Outwardly- and inwardly-extending threads 38 and 40, respectively, are used to thread wedge ring 42 into frame 28. Friction pads 44 are mounted to an outwardly-facing surface of wedge ring 42, usually by gluing the pads to a groove in the wedge ring. The outer diameters of pads 44 press outwardly against the inner diameter of bowl support 32 during crushing operations as will be described below, but are not fastened or otherwise mounted to the bowl support. They provide friction resistance to relative movement between wedge ring 42 and bowl support 32, which is helpful during crushing operations. To avoid excessive friction between friction pads 44 and bowl support 32, grease may be provided to the interface via grease lines 43.

FIG. 2 shows wedge ring 42 in a relaxed or “original” position vis-à-vis threads 38 in frame 28 before the crusher is performing crushing operations. With the threads in this relative position, there is little outward pressure being exerted by wedge ring 42 and its friction pads 44 against bowl support 32.

Positioned immediately below and in contact with wedge ring 42 are a series of evenly-spaced wedge ring cylinders 46. Another way to describe the positioning of wedge ring cylinders 46 is to say that they are disposed under and around the wedge ring, meaning they are spaced around the wedge ring and the periphery of the cone crusher. In the depicted embodiment, wedge ring cylinder 46 is a single acting hydraulic cylinder although it may be pneumatically powered.

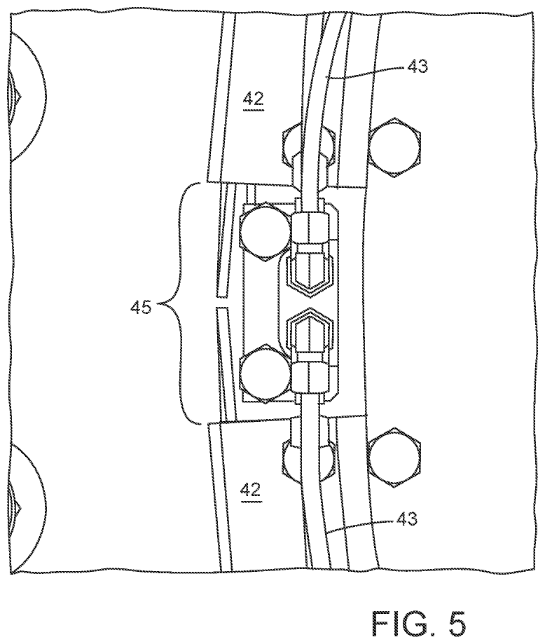

When crushing operations begin, wedge ring cylinder 46 is extended from its original position to an operational position, exerting an upward force on wedge ring 42. Forcing wedge ring 42 upwardly moves the wedge ring threads 40 up frame threads 38, forcing the wedge ring radially outwardly, causing friction pads 44 to exert an outward force on the inner diameter of bowl support 32. This radial outward movement of the wedge ring is facilitated by the fact that wedge ring 42 is split at gap 45 as shown in FIGS. 4 and 5. The friction caused by the outward force of the wedge ring friction pads 44 on bowl support 32 helps hold the bowl support in position during crushing operations, thus maintaining the so-called “close side setting” of the crusher, or the dimension of crushing space 20 when mantle 14 is closest to bowl liner 18, where the crushing is actually taking place.

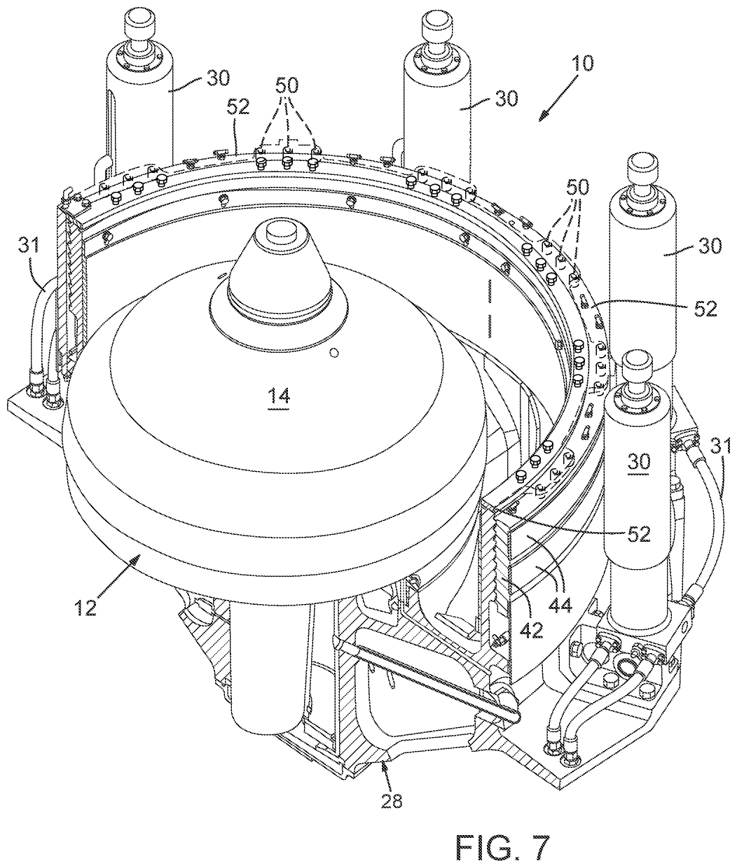

The upward displacement of wedge ring 42 compresses a series of wedge ring springs 50 evenly-spaced around the periphery of the wedge ring between the wedge ring and the lower surface of a spring hold down ring 52, shown best in FIG. 7. Another way to describe the positioning of wedge ring springs 50 is to say that they are disposed above and around the wedge ring, meaning they are spaced around the wedge ring and the periphery of the cone crusher. The function of wedge ring springs 50 will be described as this discussion continues.

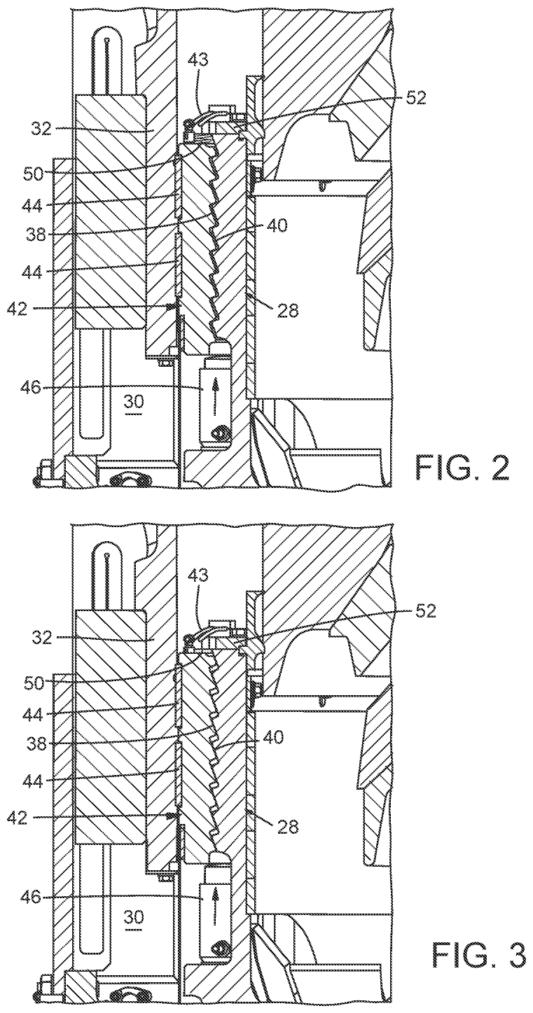

Friction pads 44 exerting an outward force on the inner diameter of bowl support 32 act as a brake on the upward movement of the bowl support. However, in the event clamping cylinders 30 sense excessive pressure as a result of uncrushables entering the crushing space, the clamping cylinder(s) on that side of the crusher pop open, permitting bowl 16 and bowl support 32 to which it is mounted to elevate, quickly opening crushing space 20. This relieves the pressure and protects the crusher from damage. Even though wedge ring 42 has been pushed upwardly by wedge ring cylinders 46 to the position of FIG. 3, exerting pressure against the inner diameter of bowl support 32, the upward forces cause by the uncrushables in the crushing space far exceeds that friction and the bowl and bowl support quickly move upwardly, permitting the uncrushables to pass. Once the pressure is relieved, clamping cylinders 30 move bowl liner 18 and bowl support 32 back to their operational positions.

It is sometimes necessary to repair or replace bowl liner 18 due to damage or wear. In order to perform this operation, it is imperative that wedge ring 42 be in its original position depicted in FIG. 2. Once crushing operations are completed, gravity causes wedge ring cylinders 46 to retract, and gravity acting on the wedge ring should cause it to drop from the position in FIG. 3 to the position in FIG. 2. However, as noted above, debris, rust or other impediments often collect within the crusher such that they wedge ring may not simply drop to its original position despite its weight. Wedge ring 42 could also be cocked and wedged in place. This causes difficulty because if the bowl needs to be removed, the outward pressure of wedge ring friction pads 44 on the inner diameter of bowl support 32 caused by wedge ring 42 being in its raised operational position, prevents the bowl from being removed.

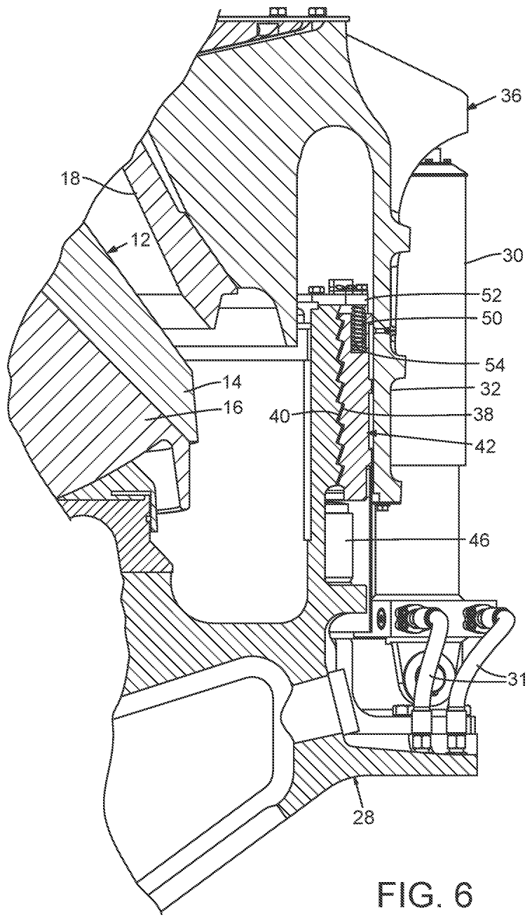

Wedge ring springs 50 are designed to assist in returning wedge ring 42 and wedge ring cylinders 46 to its original position. Springs 50 are mounted in wedge ring 42 as shown best in FIG. 6, disposed in bores 54. As shown in FIG. 7, the springs may be disposed in groups of three, spaced around the periphery of the wedge ring under compression ring 54, but this does not need to be the case as long as there are a plurality of springs 50 disposed around the wedge ring to evenly exert downward force in the ring. When wedge ring 42 is forced upwardly to its operational position shown in FIG. 4 by wedge ring cylinders 46, springs 50 are compressed, providing downward force on the wedge ring. Because the spring force is less than the force exerted by wedge ring cylinders 46, springs 50 will remain in this compressed position during crushing operations.

When crushing operations cease, the force of springs 50 around the circumference of wedge ring 42 push wedge ring cylinders 46 to their retracted positions and push the wedge ring back down to the original position depicted in FIG. 2. This causes the wedge ring to retract, releasing the pressure of friction pads 44 on the inner diameter of bowl support 32. This in turn will permit the bowl 16 and bowl support 32 to be simply lifted out of the crusher. After a replacement liner is installed in the bowl, the bowl and bowl support may be lowered into place with the bowl support again in contact with friction pads 44.

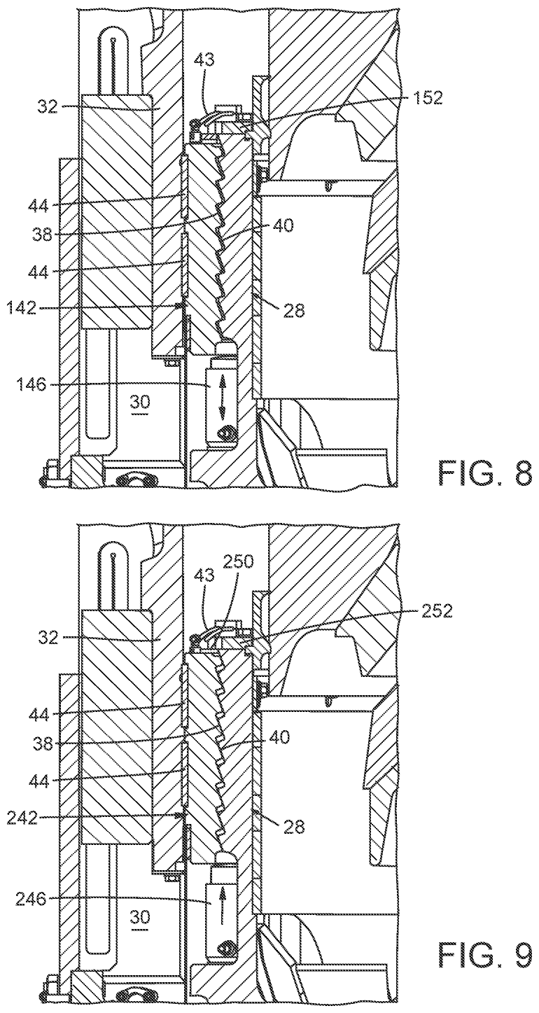

An alternative embodiment of crusher 10 is depicted in FIG. 8. All of the features of this crusher may be the same as crusher 10 except that in place of the downwardly-biasing springs 50, wedge ring cylinder 146 is designed to be double acting so it can both push and pull wedge ring 142. In this embodiment, wedge ring cylinder 146 is shown to abut the wedge ring, as it would need to be mounted to the wedge ring and frame 28 in order to apply a pulling force.

Another alternate embodiment of crusher 10 is depicted in FIG. 9. All of the features of this crusher may be the same as crusher 10 except that in place of the downwardly-biased springs 50, a series of fluid-powered cylinders 250 are positioned above wedge ring to exert a downward bias on wedge ring 242. The downward bias of cylinders 250 would normally be less than the upward bias provided by wedge ring cylinders 246 so that in the event power is being applied to both sets of cylinders simultaneously, the lower cylinders 246 would overpower the upper cylinders 250 to move the wedge ring to an operational position. It may be preferable to only have one set of the operational cylinders (either 246 or 250) applying upward or downward pressure to wedge ring 242 at any one time.

The single and double acting wedge spring cylinders 46, 146 and 246 may be described herein as means for exerting an upward force on the wedge structure or wedge ring. Springs 50, double acting wedge spring 146, and cylinders 250 may be described herein as means for exerting a downward force on the wedge structure or the wedge ring.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is intended that embodiments be limited only by the claims and the equivalents thereof.

What is claimed is:

1. A cone crusher comprising:
a bowl support;
a stationary frame to which the bowl support may be mounted, the frame including an outwardly-facing threaded portion;
a wedge structure disposed between the bowl support and the threaded portion of the frame, the wedge structure including an inwardly-facing threaded portion, the threads of which complement the outwardly facing threaded portion of the frame;
means for exerting an upward force on the wedge structure to move the wedge structure from an original position to an operational position during crushing operations; and
means for exerting a downward force on the wedge structure to return the wedge ring to the original position following crushing operations.

2. The cone crusher of claim 1 wherein the means for exerting upward and downward forces provide force at a plurality of spaced points around the wedge structure.

3. The cone crusher of claim 1 wherein the means for exerting an upward force comprises at least one fluid powered cylinder disposed under the wedge structure.

4. The cone crusher of claim 1 wherein the means for exerting a downward force comprises a plurality of spaced springs disposed above the wedge structure.

5. The cone crusher of claim 1 wherein the means for exerting a downward force comprises a plurality of fluid powered cylinders disposed above the wedge structure.

6. The cone crusher of claim 1 wherein the means for exerting an upward force and the means for exerting a downward force comprise a plurality of double-acting fluid powered cylinders disposed adjacent and mounted to the wedge structure.

7. A cone crusher comprising:
a bowl support and a crusher bowl mounted to the bowl support;
a cone mounted to a stationary frame including an outwardly-facing threaded portion;
an annular wedge ring disposed between the bowl support and the threaded portion of the frame, the wedge ring including an inwardly-facing threaded portion, the threads of which complement the outwardly facing threaded portion of the frame;
a plurality of spaced, fluid-powered wedge ring cylinders disposed around and under the wedge ring such that the wedge ring may be forced upwardly from an original position to an operational position by the wedge ring cylinders during crushing operations; and
a plurality of springs disposed around the wedge ring for exerting a downward force on the wedge ring to return the wedge ring to the original position following crushing operations.

8. A wedge ring biasing system for biasing upwardly and downwardly a threaded, annular wedge ring used in a cone crusher, the wedge ring being disposed between a cone crusher frame having threads that complement the threads of the wedge ring and a cone crusher bowl support to which is mounted a crusher bowl, the system for biasing the wedge ring upwardly comprising a plurality of fluid-powered cylinders disposed under and around the wedge ring and the system for biasing the wedge ring downwardly comprising a plurality of springs disposed above and around the wedge ring.
